(19) United States
(12) Patent Application Publication
(10) Pub. No.: US 2010/0096885 A1
(43) Pub. Date: Apr. 22, 2010

(54) TIE DOWN RAIL

(76) Inventors: Steven W. Mezzanatto, Applegate, OR (US); Michael L. Larson, Bow, WA (US)

Correspondence Address: DERGOSITS & NOAH LLP;Attn: Michael E Dergosits, Four Embarcadero Center, Suite 1450, San Francisco, CA, 94111, US

(21) Appl. No.: 12/255,965

(22) Filed: Oct. 22, 2008

(51) Int. Cl. B60R 9/06

(52) U.S. Cl. 296/193.08

(57) ABSTRACT

A tie-down rail for application to a vehicle. The vehicle is one having a horizontally extending open bed and vertically extending substantially parallel side walls, side walls having an elongated top edge and interior lip extending the length thereof. The tie-down rail includes an elongated, substantially rectangular strip sized to be fixedly secured to the inner lip and a plurality of J-hooks fixed to the rectangular strip such that upon fixing the rectangular strip to the inner lip, the J-hooks extend downwardly from the interior lip and towards the outside of the open bed.

### TECHNICAL FIELD

The present invention is directed to a tie-down rail for application to a vehicle having a passenger cab and cargo compartment. The invention is intended to improve upon the state of the art for maintaining and securing loads within the cargo department in a manner far superior to currently available options.

### BACKGROUND OF THE INVENTION

Vehicles, commonly referred to as pick up trucks, place a cargo compartment behind the vehicle's passenger cab. The cargo compartment is generally in the form of a horizontally extending open bed and vertically extending substantially parallel side walls extending from the passenger cab.

Although pick up trucks and similar vehicles can be fitted with metal, fiberglass or plastic shells to broaden their use, in most instances, the vehicle's cargo compartment or bed is merely fitted with a protective liner and is used to receive cargo being supported only by the cargo bed, side walls and flip down tail gate. Although the vehicle's cargo bed can be stacked with a variety of items, from yard debris to furniture and industrial goods, care must be taken to secure the cargo within the bed particularly if the vehicle is to move the cargo significant distances and at high speeds.

Virtually all pick up trucks are sold without any means to secure anticipated cargo. It is the responsibility of the vehicle owner to provide means for securing cargo as the need arises. Such vehicles generally employ openings spaced along the side walls of the cargo area to enable a user to attach cargo securing means as the nature of the cargo so dictates. For example, vehicle owners often times serpentine rope or cord between openings opposite one another in each side wall creating a somewhat zig-zag pattern. Such configuration is oftentimes employed to keep small loose items or yard debris within the cargo area during transport. However, it is a tedious task to thread rope or cord between opposing side walls from opening to opening only to reverse the process once the cargo is to be unloaded at its delivered destination. Others have employed bungee cords or similar devices having hooks at their extremes for securing the cords to the side wall openings as the cords are stretched over the cargo. Such securing means are also difficult to employ as the cargo volume and bed width dictate appropriate cord lengths which are not always available to a user.

U.S. Pat. No. 4,850,769 to Matthews discloses a tie-down device with a movable car slidably carried on a stationary track. Such a device has several inherent disadvantages. The number of movable cars limits the number of tie-down points available for use in securing cargo. The movable cars must be relocated for every cargo to provide the proper location for tying down cargo. The stationary track is susceptible to damage that can prevent the proper location of the movable cars.

U.S. Pat. No. 4,650,382 to Johnson describes a unitary tie-down rail with a plurality of longitudinal slots for tying down cargo that mounts on top of the side wall of a pick up truck. This device is inferior for such a mounting is inherently weaker due to the torque applied to the top of the side wall from loads. The longitudinal slots are also less secure for the mounting of cargo as the mounting hooks or straps may slide up and down the slot. This device also interferes with the use of a truck topper or cap.

U.S. Pat. No. 5,364,211 to Lund discloses a side rail anchor bar that can be mounted on the top or the outside of the side wall of the pick up. This device utilizes tie-down fingers which extend beyond the normal exterior of the pick up truck. As such these fingers are susceptible to damage. This device also interferes with the use of a truck topper or cap.

U.S. Pat. No. 4,850,770 to Miller discloses a side rail tie down anchor comprising a clamp securable to the upper edge or side rail of a pick up truck box side wall or the like. A hook providing for the securing of a tie-down rope extends from the clamp. This device is not permanently attached, and the anchors need to be repositioned for use with different cargos.

U.S. Pat. No. 5,302,064 to Davis discloses a cargo tie-down that is permanently attached to the bed of a pick up truck. This device actually uses up space in the box that could normally be used for cargo and interferes with the normal use of the pick up box. This device also provides relatively few anchor points and its use is limited to thin, flat or narrow articles.

As is quite apparent from the above discussion, none of the tie-down or securing means suggested by the prior art either individually or in combination can be employed without significant compromise and limitations.

It is thus an object of the present invention to provide a tie-down expedient for application to a vehicle capable of being employed on virtually any such vehicle having a cargo compartment and which can be used for a wide variety of cargo items to be transported.

These and further objects will be more readily apparent when considering the following disclosure and appended claims.

### SUMMARY OF THE INVENTION

The present invention is directed to a tie-down rail for application to a vehicle having a passenger cab and cargo compartment in the form of a horizontally extending open bed and vertically extending substantially parallel side walls extending from the passenger cab along the open bed. Each of the side walls is provided with an elongated top having an interior lip extending therefrom. The tie-down rail comprises an elongated, flat, substantially rectangular mounting bar sized to be fixedly secured to said interior lip and a plurality of J-hooks fixed to said mounting bar such that upon fixing said mounting bar to said interior lip, said J-hooks extend downwardly from said interior lip and towards outside of said bed.

### BRIEF DESCRIPTION OF THE FIGURES

FIG. 1 is a perspective drawing of the tie-down rail of the present invention.

FIG. 2 is a partial perspective view of the tie-down rail of FIG. 1 being secured to the cargo area of a vehicle for use thereon.

FIG. 3 is a rear plan view of the cargo area of a vehicle illustrating use of the present tie-down rail to secure cargo.

### DETAILED DESCRIPTION OF THE INVENTION

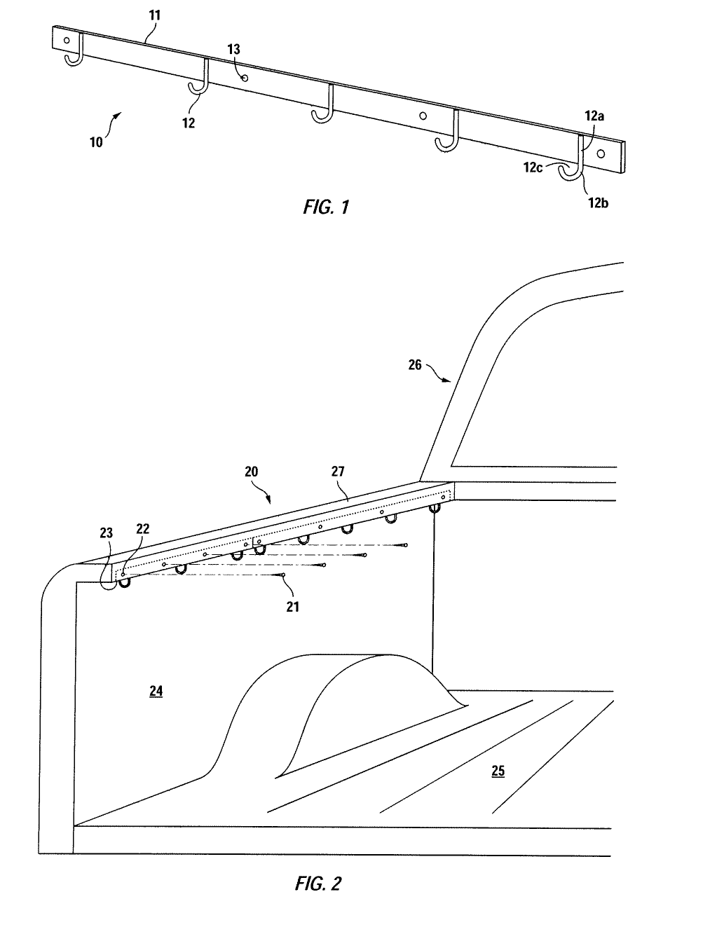

Turning first to FIG. 1, tie-down rail 10 is depicted for application to vehicle 20 (FIG. 2), the vehicle having passenger cab 26 and cargo compartment 25 in the form of a horizontally extending open bed and vertically extending substantially parallel side walls 24 extending from cab 26 along open bed 25. Each of side walls 24 is characterized as having an elongated top edge 27 having an interior lip 23 extending the length thereof.

Turning once again to FIG. 1, tie-down rail 10 comprises an elongated, flat, substantially rectangular mounting bar 11 generally configured from flat steel stock or similar wear resistant member in the form of substantially rectangular strips sized to be fixedly secured to inner lip 23 of side wall 24. Mounting bar 11 is provided to fit within lip 23 such that a plurality of J-hooks 12 welded or otherwise fixed to rectangular strip 11 extend below lip 23, preferably at evenly spaced intervals. A plurality of tie-down rails 10 can be abutted, end to end so that J-hooks 12 can be evenly spaced along the entire length of side wall 24 as depicted in FIG. 2. As noted, J-hooks 12 extend downwardly from inner lip 23 toward the outside of said open bed 25 by configuring holes 22 within side wall 24 intended to mate with openings 13 of mounting bar 11 to enable screws 21 or similar fasteners to simply and conveniently secure tie-down rail 10 as shown.

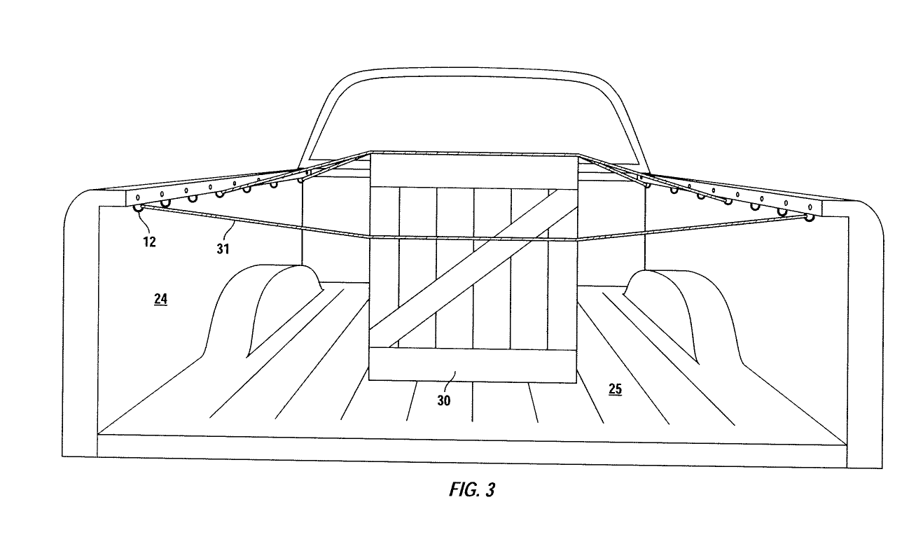

When tie-down rail 10 is secured as depicted, J-hooks 12 which comprise first segment 12A appended to mounting bar 11 transitions into second segment 12B being substantially C-shaped and creating open region 12C extending away from the cargo area. In doing so, plurality of J-hooks 12 are caused to protrude below inner lip 23 to create conveniently exposed hooks for securing cord, rope, wire or similar expedients for holding and maintaining cargo. In this regard, reference is made to FIG. 3.

Turning to FIG. 3, cargo 30 is shown residing upon bed 25 essentially located within the cargo area. To secure cargo 30 in place, rope 31 is connected between opposing J-hooks 12. As noted, depending upon the cargo, not all J-hooks need be employed.

There are advantages which should come readily apparent when considering the present disclosure. For example, for the first time, one is able to provide tie-down points that are readily available without requiring repositioning of a movable car or anchor. The present tie-down rail can be employed in conjunction with a truck topper or cap while not interfering with the mounting or dismounting of these after market products. Because the tie-down rails are positioned within the inner lip of the cargo compartment side walls, the J-hooks are resistant to impact damage while providing anchor points, at the discretion of the user, along the entire length of the truck box. Further, J-hooks 12 can mate with cargo nets and tops that provide additional cargo protection. This is particularly advantageous when the cargo is loose, such as yard debris which must be protected against wind impact during transport. Finally, as is readily apparent, the present tie-down rail can be employed to fit a large variety of pick up trucks and are thus not dependent upon a single manufacturer's design. Mounting bars can be produced in segments of standard lengths. By installing them end to end, trucks of standard bed lengths can receive what amounts to a composite of multiple mounting bars to present J-hooks along the entire bed. Such flexibility has been unavailable before the advent of the present invention.

Once installed, a cord, rope, or bungee can be fixed by securing it to one J-hook and then serpentined between hooks on opposite sides of the open bed for creating a web for securing a load. An open mesh web can also be used with the present invention with portions of the mesh engaging various J-hooks positioned along the open bed.

What is claimed is:

1. A tie-down rail for application to a vehicle having a passenger cab and cargo compartment in the form of a horizontally extending open bed and vertically extending substantially parallel side walls extending from said passenger cab along said open bed, each of said side walls having an elongated top edge having an interior lip extending the length thereof, the tie-down rail comprising an elongated, flat substantially rectangular mounting bar sized to be fixedly secured to said interior lip and a plurality of J-hooks fixed to said mounting bar such that upon fixing said mounting bar to said interior lip, said J-hooks extend downwardly from said interior lip and toward the outside of said open bed.

2. The tie-down rail of claim 1 wherein said J-hooks comprise a first segment appended to said mounting bar, a second segment being substantially C-shaped and an open region at termination of said C-shaped segment.

3. The tie-down rail of claim 2 wherein upon its installation to said inner lip, said C-shaped segment extends inwardly within said cargo compartment and said open regions extends toward said side wall supporting said inner lip to which said tie-down has been fixedly attached.

4. The tie-down rail of claim 1 wherein a plurality of J-hooks are evenly spaced along said mounting bar.

5. The tie-down rail of claim 1 further comprising a plurality of fasteners for passing through said side walls and mounting bars for securing said tie-down rail to said vehicle.

6. The tie-down rail of claim 1 wherein mounting bars are applied to said side walls such that a plurality of J-hooks are caused to protrude below said inner lips substantially along the entire length of said bed.

7. In combination, a tie-down rail and vehicle, said vehicle having a passenger cab and cargo compartment in the form of a horizontally extending open bed and vertically extending substantially parallel side walls extending from said passenger cab along said open bed, each of said side walls having an elongated top edge having an interior lip extending the length thereof, said tie-down rail comprising an elongated, flat substantially rectangular mounting bar sized to be fixedly secured to said inner lip and a plurality of J-hooks fixed to said mounting bar such that, in combination, said mounting bar is fixed to said inner lip causing said J-hooks to extend downwardly from said inner lip and toward the outside of said open bed.

8. The combination of claim 7 wherein said J-hooks comprise a first segment applied to said mounting bar, a second segment being substantially C-shaped and an open region at the termination of said C-shaped segment.

9. The tie-down rail of claim 8 wherein upon the installation of said tie-down rail to said inner lip, said C-shaped segment extends inwardly of said cargo compartment and said open region extends towards said side wall supporting said inner lip to which said tie-down rail has been fixedly attached.

10. The combination of claim 7 wherein a plurality of J-hooks are evenly spaced along said mounting bar.

11. The combination of claim 7 further comprising a plurality of fasteners for passing through said side walls and mounting bar for securing said tie-down rail to said vehicle.

12. The combination of claim 7 wherein mounting bars are applied to said side walls such that a plurality of J-hooks are caused to protrude below said inner lip substantially along the entire length of said bed.

13. A method of securing a load to the bed of a vehicle, said vehicle having a passenger cab and cargo department in the form of a horizontally extending open bed and vertically extending substantially parallel side walls extending from said passenger cab along said open bed, each of said side walls having an elongated top edge having an interior lip extending the length thereof; providing tie down rails along the interior lip of each side wall, said tie down rails comprising elongated, flat, substantially rectangular mounting bars and a plurality of J-hooks fixed to said mounting bars extending downwardly from said inner lip and toward the outside of said open bed upon application of the mounting bars to said side walls, and passing a cord between J-hooks, said cord substantially preventing movement of said load within said bed.

14. The method of claim 13 wherein said cord is fixedly secured to one J-hook and serptines between hooks on opposite sides of said open bed creating a web for securing said load.

15. The method of claim 13 wherein said cord comprises an elasticized bungee cord.

16. The method of claim 13 wherein said cord comprises an open mesh web, portions of said open mesh engaging various J-hooks positioned along said open bed.
